(19) United States
(12) Patent Application Publication
(10) Pub. No.: US 2023/0260162 A1
(43) Pub. Date: Aug. 17, 2023

(54) ENCODING SYSTEM, ENCODING METHOD, AND COMPUTER-READABLE RECORDING MEDIUM STORING ENCODING PROGRAM

(71) Applicant: FUJITSU LIMITED, Kawasaki-shi (JP)

(72) Inventors: Tomonori KUBOTA, Kawasaki (JP); Takanori NAKAO, Kawasaki (JP)

(73) Assignee: FUJITSU LIMITED, Kawasaki-shi (JP)

(21) Appl. No.: 18/302,834

(22) Filed: Apr. 19, 2023

Related U.S. Application Data
(63) Continuation of application No. PCT/JP2020/048568, filed on Dec. 24, 2020.

(51) Int. Cl. G06T 9/00; G06V 10/28

(52) U.S. Cl. CPC G06T 9/00; G06V 10/28

(57) ABSTRACT

An encoding system includes: a memory; and a processor coupled to the memory and configured to: calculate, for each area, for a first image, a quantization value that has a compression ratio according to a degree of influence on recognition accuracy during recognition processing; set, when setting the quantization value calculated for each area, for each area of a second image that is acquired after the first image, a quantization value that has a compression ratio lower than the compression ratio, for a specific area other than an area that corresponds to an area of an object to be recognized included in the first image; and encode the second image, using the quantization value.

### CROSS-REFERENCE TO RELATED APPLICATION

This application is a continuation application of International Application PCT/JP2020/048568 filed on Dec. 24, 2020 and designated the U.S., the entire contents of which are incorporated herein by reference.

### FIELD

The embodiments discussed herein are related to an encoding system, an encoding method, and an encoding program.

### BACKGROUND

Commonly, when image data is recorded or transmitted, recording cost and transmission cost are reduced by reducing a data size by encoding processing.

Japanese Laid-open Patent Publication No. 2020-068008 and Japanese Laid-open Patent Publication No. 2009-117997 are disclosed as related art.

### SUMMARY

According to an aspect of the embodiments, an encoding system includes: a memory; and a processor coupled to the memory and configured to: calculate, for each area, for a first image, a quantization value that has a compression ratio according to a degree of influence on recognition accuracy during recognition processing; set, when setting the quantization value calculated for each area, for each area of a second image that is acquired after the first image, a quantization value that has a compression ratio lower than the compression ratio, for a specific area other than an area that corresponds to an area of an object to be recognized included in the first image; and encode the second image, using the quantization value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of a system configuration of an encoding system;

FIG. 2 is a diagram illustrating an example of hardware configurations of an edge device and a server device;

FIG. 3 is a first diagram illustrating a relationship between an updated quantization value map applied to each frame image of a moving image and a recognition result;

FIG. 4 is a second diagram illustrating the relationship between the updated quantization value map applied to each frame image of a moving image and the recognition result;

FIG. 5 is a third diagram illustrating the relationship between the updated quantization value map applied to each frame image of a moving image and the recognition result;

FIG. 6 is a fourth diagram illustrating the relationship between the updated quantization value map applied to each frame image of a moving image and the recognition result;

FIG. 7 is a diagram illustrating an example of a functional configuration of an analysis unit;

FIG. 8 is a diagram illustrating a specific example of an aggregation result;

FIG. 9 is a diagram illustrating a specific example of processing of a quantization value generation unit;

FIG. 10 is a diagram illustrating an example of a functional configuration of an update unit;

FIG. 11 is a first flowchart illustrating a flow of encoding processing;

FIG. 12 is a second diagram illustrating an example of the system configuration of the encoding system;

FIG. 13 is a first diagram illustrating a relationship between a corrected quantization value map to be applied to each frame image of a moving image and a recognition result;

FIG. 14 is a second diagram illustrating the relationship between the corrected quantization value map to be applied to each frame image of a moving image and the recognition result; and

FIG. 15 is a second flowchart illustrating a flow of encoding processing.

### DESCRIPTION OF EMBODIMENTS

Meanwhile, in a case of recording or transmitting image data for the purpose of use in recognition processing by artificial intelligence (AI), it is conceivable to perform encoding processing by increasing a compression ratio to a limit at which the AI can recognize an object to be recognized (for example, at a limit compression ratio).

However, in a case where it takes time to calculate the limit compression ratio, a frame image used for calculation of the limit compression ratio is different from a frame image to which the calculated limit compression ratio is applied when moving image data is transmitted in real time. As a result, there may be a case where an object to be recognized that is not included in the frame image used for calculation of the limit compression ratio is newly included in the frame image to which the limit compression ratio is applied.

In such a case, since the encoding processing is performed by applying the limit compression ratio of an object not to be recognized to the new object to be recognized, it is difficult to recognize the new object to be recognized at the time of decoding.

In one aspect, an object is to suppress an influence on recognition accuracy caused by encoding processing for a moving image.

Hereinafter, each embodiment will be described with reference to the attached drawings. Note that, in the description here and the drawings, components having substantially the same functional configuration are denoted by the same reference numerals, and redundant description is omitted.

### First Embodiment

### System Configuration of Encoding System

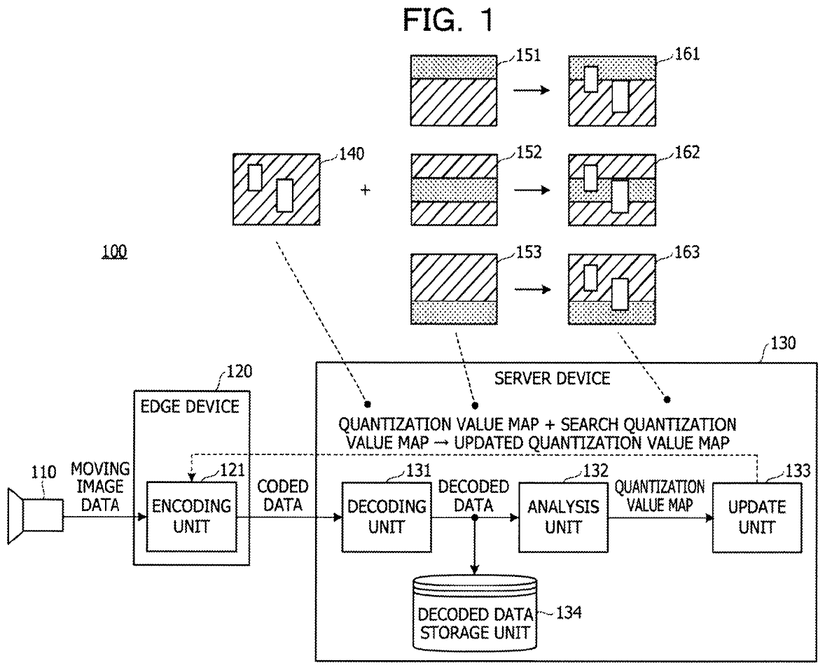

First, a system configuration of an encoding system according to a first embodiment will be described. FIG. 1 is a first diagram illustrating an example of the system configuration of the encoding system. As illustrated in FIG. 1, an encoding system 100 includes an imaging device 110, an edge device 120, and a server device 130. In the encoding system 100, the edge device 120 and the server device 130 are communicably coupled via a network.

The imaging device 110 performs imaging at a predetermined frame period and transmits moving image data to the edge device 120. Note that the moving image data includes at least a frame image including an object (object to be recognized) targeted for recognition processing and a frame image (including only an object not to be recognized) not including the object (object to be recognized) targeted for the recognition processing. Moreover, the moving image data may include a frame image that does not include an object.

An encoding program is installed in the edge device 120, and the edge device 120 functions as an encoding unit 121 when the encoding program is executed.

The encoding unit 121 sets a quantization value (also referred to as a quantization step, hereinafter, the same is similarly applicable) instructed by the server device 130, and encodes each frame image of the moving image data to generate coded data. Furthermore, the encoding unit 121 transmits the generated coded data to the server device 130.

Note that the encoding unit 121 is instructed by the server device 130 with quantization values for each block that is a processing unit at the time of encoding. Hereinafter, a set of the quantization values indicated for each block is referred to as a “quantization value map”.

In the present embodiment, the encoding unit 121 acquires an updated quantization value map (details will be described below) from the server device 130, and encodes each frame image of the moving image data using the updated quantization value map.

A decoding program is installed in the server device 130, and the server device 130 functions as a decoding unit 131, an analysis unit 132, and an update unit 133 when the decoding program is executed.

The decoding unit 131 decodes the coded data transmitted from the edge device 120 to generate decoded data. The decoding unit 131 stores the generated decoded data in a decoded data storage unit 134. Furthermore, the decoding unit 131 notifies the analysis unit 132 of the generated decoded data.

The analysis unit 132 analyzes the decoded data notified from the decoding unit 131 and generates the quantization value map. For example, the analysis unit 132 calculates a degree of influence on recognition accuracy, of each area of the decoded data at the time of the recognition processing, by performing the recognition processing for the decoded data. Furthermore, the analysis unit 132 aggregates the degree of influence of each area for each block and calculates a quantization value according to an aggregation result to generate a quantization value map 140 according to the degree of influence on the recognition accuracy.

Note that, in the quantization value map 140 of FIG. 1, a white rectangular area indicates, in the corresponding decoded data,
an area in which the object to be recognized is recognized, and
an area in which the quantization value having a limit compression ratio for recognizing the object to be recognized or the quantization value in an ongoing process to reach the limit compression ratio for recognizing the object to be recognized is set. Furthermore, in the quantization value map 140, a hatched area indicates, in the corresponding decoded data,
an area in which the object to be recognized is not recognized, and
an area in which the quantization value having the limit compression ratio of the object not to be recognized (the limit compression ratio higher than the limit compression ratio for recognizing the object to be recognized) or the quantization value in an ongoing process to reach the limit compression ratio of the object not to be recognized is set.

The update unit 133 generates a search quantization value map in consideration of a possibility that a new object to be recognized not included in the decoded data used when generating the quantization value map 140 is included in the next frame image to which the quantization value map 140 is applied.

For example, the update unit 133 generates search quantization value maps 151 to 153 so that the quantization value having the compression ratio lower than the quantization value set for the hatched area is set for a part of the hatched area in the quantization value map 140.

Every time the quantization value map 140 is notified from the analysis unit 132, the update unit 133 superimposes one of the search quantization value maps 151 to 153 on the notified quantization value map 140 to generate one of updated quantization value maps 161 to 163.

Note that, in the search quantization value maps 151 to 153, a shaded rectangular area is an area in which the quantization value having the compression ratio lower than the hatched area of the quantization value map 140 is set. The example of FIG. 1 illustrates a state in which one of the following maps is generated:
the search quantization value map 151 in which the quantization value having the compression ratio lower than the hatched area of the quantization value map 140 is set at a position of a band-shaped area (an example of a specific area) in an upper part of the frame image;
the search quantization value map 152 in which the quantization value having the compression ratio lower than the hatched area of the quantization value map 140 is set at the position of the band-shaped area in a middle part of the frame image; or
the search quantization value map 153 in which the quantization value having the compression ratio lower than the hatched area of the quantization value map 140 is set at the position of the band-shaped area in a lower part of the frame image.

Note that the update unit 133 selects a lower quantization value for each block, for example, and generates the updated quantization value map when sequentially superimposing the search quantization value maps 151 to 153 on the quantization value map 140. For example, the update unit 133 lowers and sets the quantization value of the block included in the band-shaped area (=specific area) in an area other than an area corresponding to an area of the object to be recognized.

Furthermore, the update unit 133 transmits one of the generated updated quantization value maps 161 to 163 to the edge device 120.

Note that the above-described white rectangular area is not limited to a rectangle as long as the area has a shape determined according to a recognition result or a derivation result of the limit compression ratio, and may have a shape other than a rectangle. Furthermore, the shape, arrangement, and the like of the shaded rectangular area are not limited to the example of FIG. 1.

### Hardware Configurations of Edge Device and Server Device

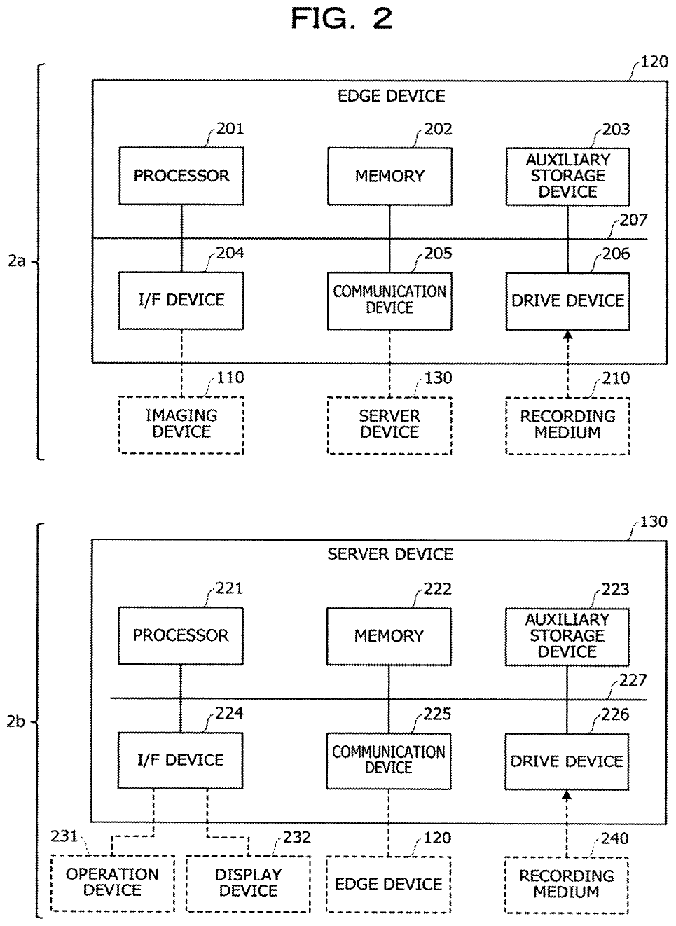

Next, hardware configurations of the edge device 120 and the server device 130 will be described. FIG. 2 is a diagram illustrating an example of the hardware configurations of the edge device and the server device.

In the drawing, 2a of FIG. 2 is a diagram illustrating an example of the hardware configuration of the edge device. The edge device 120 includes a processor 201, a memory 202, an auxiliary storage device 203, an interface (I/F) device 204, a communication device 205, and a drive device 206. Note that the respective pieces of hardware of the edge device 120 are mutually coupled via a bus 207.

The processor 201 includes various arithmetic devices such as a central processing unit (CPU) or a graphics processing unit (GPU). The processor 201 reads various programs (for example, an encoding program and the like) into the memory 202 and executes the programs.

The memory 202 includes a main storage device such as a read only memory (ROM) or a random access memory (RAM). The processor 201 and the memory 202 form a so-called computer. The processor 201 executes the various programs read into the memory 202 to cause the computer to implement various functions.

The auxiliary storage device 203 stores various programs and various types of data used when the various programs are executed by the processor 201.

The I/F device 204 is a coupling device that couples the imaging device 110, which is an example of an external device, and the edge device 120.

The communication device 205 is a communication device for communicating with the server device 130, which is an example of another device.

The drive device 206 is a device in which a recording medium 210 is set. The recording medium 210 mentioned here includes a medium that optically, electrically, or magnetically records information, such as a compact disc read only memory (CD-ROM), a flexible disk, or a magneto-optical disk. Furthermore, the recording medium 210 may include a semiconductor memory or the like that electrically records information, such as a ROM or a flash memory.

Note that the various programs to be installed in the auxiliary storage device 203 are installed, for example, when the distributed recording medium 210 is set in the drive device 206, and the various programs recorded on the recording medium 210 are read by the drive device 206. Alternatively, the various programs to be installed in the auxiliary storage device 203 may be installed by being downloaded from a network via the communication device 205.

Meanwhile, 2b of FIG. 2 is a diagram illustrating an example of the hardware configuration of the server device 130. Note that since the hardware configuration of the server device 130 is substantially the same as the hardware configuration of the edge device 120, differences from the edge device 120 will be mainly described here.

For example, a processor 221 reads a decoding program or the like into a memory 222 and executes the program.

An I/F device 224 receives an operation for server device 130 via an operation device 231. Furthermore, the I/F device 224 outputs a result of processing by the server device 130 and displays the result via a display device 232. Furthermore, a communication device 225 communicates with the edge device 120.

### Relationship (1) Between Updated Quantization Value Map and Recognition Result

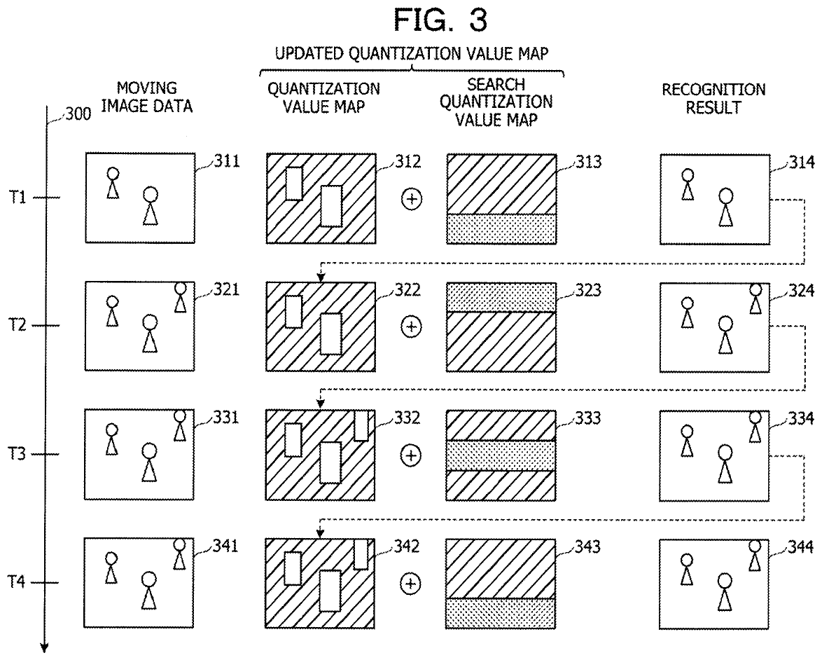

Next, a relationship between the updated quantization value map (the quantization value map and the search quantization value map) applied to each frame image of a moving image and a result of the recognition processing for the corresponding decoded data will be described. FIG. 3 is a first diagram illustrating the relationship between the updated quantization value map applied to each frame image of the moving image and the recognition result.

In FIG. 3, a vertical axis 300 represents a time axis, and the example of FIG. 3 indicates that the edge device 120 has acquired frame images 311 to 341 of the moving image at time T1 to time T4, respectively. Note that, in the case of the example of FIG. 3, while two persons are included in the frame image 311 as the objects to be recognized at the time T1, three persons are included in the frame images 321, 331, and 341 as the objects to be recognized at the time T2 to time T4.

Furthermore, the example of FIG. 3 illustrates a state in which the edge device 120 performs encoding processing for the frame image 311 (an example of a first image) acquired at the time T1, using the updated quantization value map obtained by superimposing a search quantization value map 313 on a quantization value map 312. Moreover, the example of FIG. 3 illustrates a state in which the server device 130 decodes coded data generated by performing the encoding processing for the frame image 311 and performs the recognition processing for the decoded data to obtain a recognition result 314.

According to the example of FIG. 3, by use of the quantization value map 312 in which the quantization value of the area corresponding to the area in which the objects to be recognized (two persons) are located in the frame image 311 is set to be low, the area of the object to be recognized is reproduced with accuracy in the decoded data. As a result, as illustrated in the recognition result 314, the server device 130 can recognize the objects to be recognized (two persons) in the decoded data.

Note that, in this case, the server device 130 generates the quantization value map according to the recognition result 314. The example of FIG. 3 illustrates a state in which a quantization value map 322 is generated according to the recognition result 314.

Furthermore, the example of FIG. 3 illustrates a state in which the edge device 120 performs the encoding processing for the frame image 321 (an example of a second image) acquired at the time T2, using the updated quantization value map obtained by superimposing a search quantization value map 323 on a quantization value map 322. Moreover, the example of FIG. 3 illustrates a state in which the server device 130 decodes coded data generated by performing the encoding processing for the frame image 321 and performs the recognition processing for the decoded data to obtain a recognition result 324.

In the case of the example of FIG. 3, the quantization value map 322 in which the quantization value of a part (the area where the new object to be recognized is located) of the areas where the objects to be recognized (three persons) are located in the frame image 321 is not set to be low is used.

However, in the case of the example of FIG. 3, the quantization value of the band-shaped area in the upper part of the frame image 321 is set to be low in the search quantization value map 323. Therefore, in the decoded data, the area where the new object to be recognized is located is reproduced with high accuracy. As a result, the server device 130 can recognize the objects to be recognized (three persons) in the decoded data (see the recognition result 324)

Note that, in this case, the server device 130 generates the quantization value map according to the recognition result 324. The example of FIG. 3 illustrates a state in which a quantization value map 332 is generated according to the recognition result 324.

Furthermore, the example of FIG. 3 illustrates a state in which the edge device 120 performs the encoding processing for the frame image 331 acquired at the time T3, using the updated quantization value map obtained by superimposing a search quantization value map 333 on a quantization value map 332. Moreover, the example of FIG. 3 illustrates a state in which the server device 130 decodes coded data generated by performing the encoding processing for the frame image 331 and performs the recognition processing for the decoded data to obtain a recognition result 334.

According to the example of FIG. 3, by use of the quantization value map 332 in which the quantization value of the area corresponding to the area in which the objects to be recognized (three persons) are located in the frame image 331 is set to be low, the area of the object to be recognized is reproduced with accuracy in the decoded data. As a result, as illustrated in the recognition result 334, the server device 130 can recognize the objects to be recognized (three persons) in the decoded data.

Note that, in this case, the server device 130 generates the quantization value map according to the recognition result 334. The example of FIG. 3 illustrates a state in which a quantization value map 342 is generated according to the recognition result 334.

Furthermore, the example of FIG. 3 illustrates a state in which the edge device 120 performs the encoding processing for the frame image 341 acquired at the time T4, using the updated quantization value map obtained by superimposing a search quantization value map 343 on a quantization value map 342. Moreover, the example of FIG. 3 illustrates a state in which the server device 130 decodes coded data generated by performing the encoding processing for the frame image 341 and performs the recognition processing for the decoded data to obtain a recognition result 344.

According to the example of FIG. 3, by use of the quantization value map 342 in which the quantization value of the area corresponding to the area in which the objects to be recognized (three persons) are located in the frame image 341 is set to be low, the area of the object to be recognized is reproduced with accuracy in the decoded data. As a result, as illustrated in the recognition result 344, the server device 130 can recognize the objects to be recognized (three persons) in the decoded data.

In this manner, it is possible to recognize the new object to be recognized by using the search quantization value map.

### Relationship (2) Between Updated Quantization Value Map and Recognition Result

Next, the relationship between the updated quantization value map (the quantization value map and the search quantization value map) applied to each frame image of the moving image and the result of the recognition processing for the corresponding decoded data will be described using a specific example different from FIG. 3.

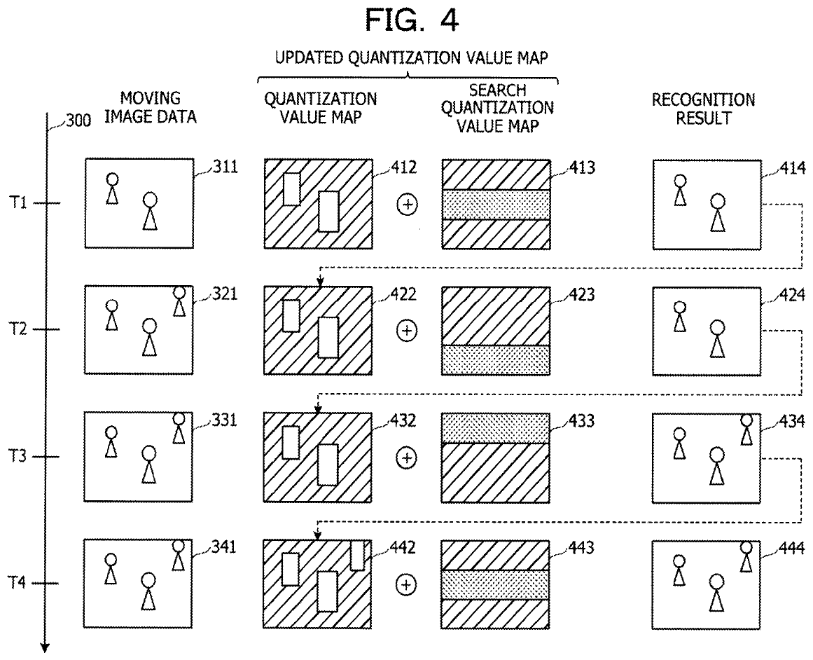

FIG. 4 is a second diagram illustrating the relationship between the updated quantization value map applied to each frame image of the moving image and the recognition result. The difference from FIG. 3 is the search quantization value map at each time.

For example, the band-shaped area in which the quantization value lower than that in the hatched area is set is located in the lower part at the time T1 in FIG. 3, whereas the band-shaped area is located in the middle part at the time T1 in FIG. 4. Similarly, the band-shaped area in which the quantization value lower than that in the hatched area is set is located in the upper part at the time T2 in FIG. 3, whereas the band-shaped area is located in the lower part at the time T2 in FIG. 4. Similarly, the band-shaped area in which the quantization value lower than that in the hatched area is set is located in the middle part at the time T3 in FIG. 3, whereas the band-shaped area is located in the upper part at the time T3 in FIG. 4. Similarly, the band-shaped area in which the quantization value lower than that in the hatched area is set is located in the lower part at the time T4 in FIG. 3, whereas the band-shaped area is located in the middle part at the time T4 in FIG. 4.

As described above, the updated quantization value map is also different as the search quantization value map superimposed at each time is different. For example, in the case of the example of FIG. 4, the encoding processing is performed for the frame image 321 acquired at the time T2, using the updated quantization value map in which the search quantization value map 423 is superimposed on the quantization value map 422.

Here, according to the example of FIG. 4, the quantization value map 422 in which the quantization value of a part (the area where the new object to be recognized is located) of the area where the objects to be recognized (three persons) are located in the frame image 321 is not set to be low is used at the time T2.

In addition, according to the example of FIG. 4, the quantization value of the band-shaped area in the lower part of the frame image 321 is set to be low in the search quantization value map 423. Therefore, in the decoded data, the area where the new recognition result is located is not reproduced with high accuracy. As a result, the server device 130 is not able to recognize the new object to be recognized among the objects to be recognized (three persons) in the decoded data (see a recognition result 424).

Note that, in this case, the server device 130 generates the quantization value map according to the recognition result 424. The example of FIG. 4 illustrates a state in which a quantization value map 432 is generated according to the recognition result 424.

Furthermore, the example of FIG. 4 illustrates a state in which the edge device 120 performs the encoding processing for the frame image 331 acquired at the time T3, using the updated quantization value map obtained by superimposing a search quantization value map 433 on a quantization value map 432. Moreover, the example of FIG. 4 illustrates a state in which the server device 130 decodes coded data generated by performing the encoding processing for the frame image 331 and performs the recognition processing for the decoded data to obtain a recognition result 434.

Here, according to the example of FIG. 4, the quantization value map 432 in which the quantization value of a part (the area where the new object to be recognized is located) of the area where the objects to be recognized (three persons) are located in the frame image 331 is not set to be low is used at the time T3.

However, in the case of the example of FIG. 4, the quantization value of the band-shaped area in the upper part of the frame image 331 is set to be low in the search quantization value map 433. Therefore, in the decoded data, the area where the new object to be recognized is located is reproduced with high accuracy. As a result, the server device 130 can recognize the objects to be recognized (three persons) in the decoded data (see the recognition result 434)

Note that, in this case, the server device 130 generates the quantization value map according to the recognition result 434. The example of FIG. 4 illustrates a state in which a quantization value map 442 is generated based on the recognition result 434. Thereafter, at the time T4, processing similar to the processing at the time T3 in FIG. 3 is performed.

In this way, by using the search quantization value map, it is possible to recognize the new object to be recognized with a delay of one frame image.

### Relationship (3) Between Updated Quantization Value Map and Recognition Result

Next, the relationship between the updated quantization value map (the quantization value map and the search quantization value map) applied to each frame image of the moving image and the result of the recognition processing for the corresponding decoded data will be described using a specific example different from FIGS. 3 and 4.

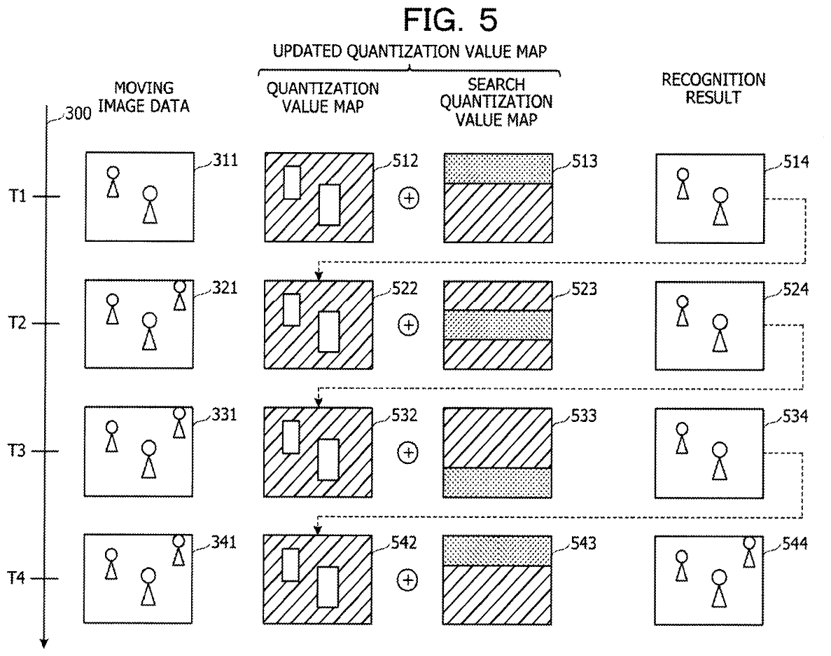

FIG. 5 is a third diagram illustrating the relationship between the updated quantization value map applied to each frame image of the moving image and the recognition result. The difference from FIGS. 3 and 4 is the search quantization value map at each time.

As illustrated in FIG. 5, depending on the relationship between timing and position at which the new object to be recognized appears and the search quantization value map superimposed at each time, the object to be recognized is not able to be correctly recognized for at most two frame images (see recognition results 524 and 534).

Meanwhile, for the frame image 341 at the time T4, the object to be recognized can be correctly recognized (see a recognition result 544). For example, according to the search quantization value map in the present embodiment, the analysis unit 132 can recognize the new object to be recognized within three frame images after the new object to be recognized appears.

### Relationship (4) Between Updated Quantization Value Map and Recognition Result

Next, the relationship between the updated quantization value map (the quantization value map and the search quantization value map) applied to each frame image of the moving image and the result of the recognition processing for the corresponding decoded data will be described using a specific example different from FIGS. 3 to 5.

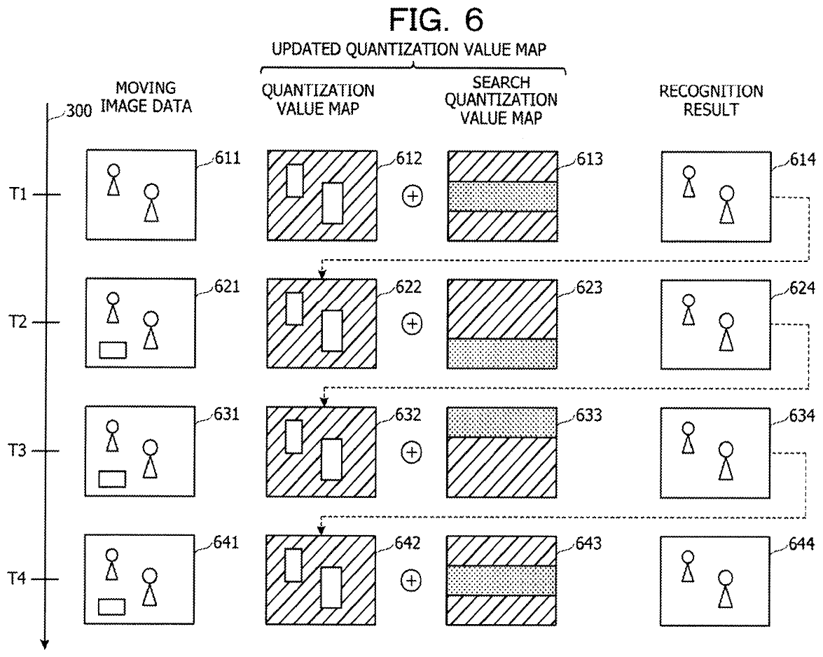

FIG. 6 is a fourth diagram illustrating the relationship between the updated quantization value map applied to each frame image of the moving image and the recognition result. A difference from FIG. 4 is the frame image at each time.

For example, the new object to be recognized appears at the time T2 in FIG. 4, whereas the new object (object not to be recognized) appears at time T2 in FIG. 6.

In the case of the example of FIG. 6, the edge device 120 performs the encoding processing for a frame image 621 acquired at the time T2, using the updated quantization value map obtained by superimposing a search quantization value map 623 on a quantization value map 622.

According to the example of FIG. 6, the quantization value map 622 in which the quantization value of the area corresponding to the area in which the objects to be recognized (two persons) are located in the frame image 621 is set to be low is used at the time T2. Therefore, in the decoded data, the area of the object to be recognized is reproduced with high accuracy.

Meanwhile, in the case of the example of FIG. 6, the quantization value of the band-shaped area in the lower part of the frame image 621 is set to be low in the search quantization value map 623. Therefore, in the decoded data, the area where the new object (object not to be recognized) is located is also reproduced with high accuracy. However, since the new object is the object not to be recognized, the new object is not recognized by the server device 130. As a result, the server device 130 recognizes only the objects to be recognized (two persons) in the decoded data (see a recognition result 624).

Note that, in this case, the server device 130 generates the quantization value map according to the recognition result 624. The example of FIG. 6 illustrates a state in which a quantization value map 632 is generated according to the recognition result 624.

Furthermore, the example of FIG. 6 illustrates a state in which the edge device 120 performs the encoding processing for a frame image 631 acquired at the time T3, using the updated quantization value map obtained by superimposing a search quantization value map 633 on a quantization value map 632. Moreover, the example of FIG. 6 illustrates a state in which the server device 130 decodes coded data generated by performing the encoding processing for the frame image 631 and performs the recognition processing for the decoded data to obtain a recognition result 634.

According to the example of FIG. 6, the quantization value map 632 in which the quantization value of the area corresponding to the area in which the objects to be recognized (two persons) are located in the frame image 631 is set to be low is used at the time T3. Therefore, in the decoded data, the area of the object to be recognized is reproduced with high accuracy.

Furthermore, in the case of the example of FIG. 6, the quantization value of the band-shaped area in the upper part of the frame image 631 is set to be low in the search quantization value map 633. Therefore, in the decoded data, the area where the object not to be recognized is located is not reproduced with high accuracy. As a result, the server device 130 recognizes only the objects to be recognized (two persons) without recognizing the new object (object not to be recognized) in the decoded data.

Note that, in this case, the server device 130 generates the quantization value map according to the recognition result 634. The example of FIG. 6 illustrates a state in which a quantization value map 642 is generated according to the recognition result 634. Thereafter, at the time T4, processing similar to the processing at the time T3 is performed.

### Functional Configuration of Analysis Unit

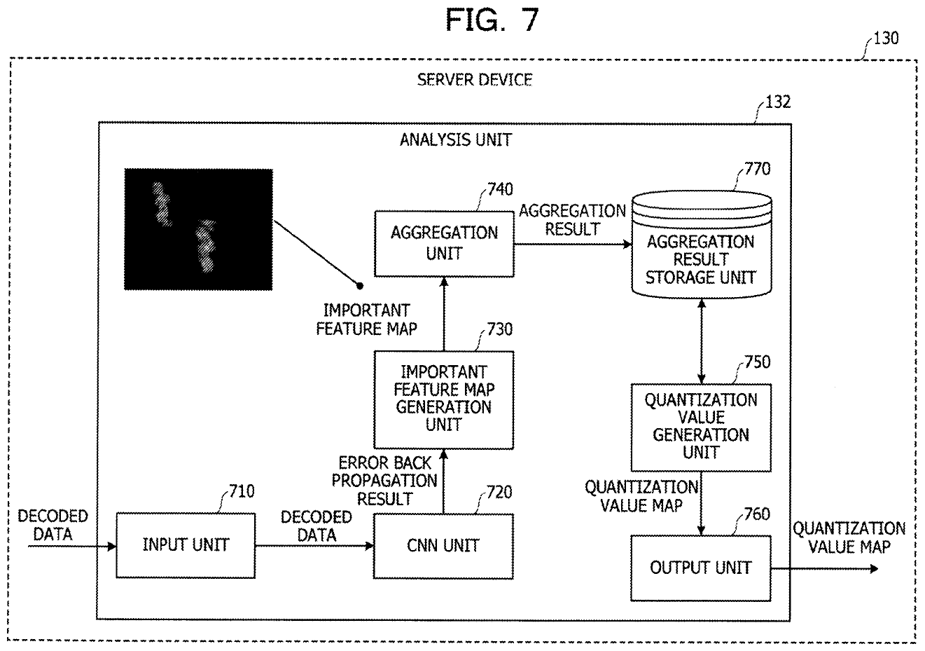

Next, a functional configuration of the analysis unit 132 of the server device 130 will be described. FIG. 7 is a diagram illustrating an example of the functional configuration of the analysis unit. As illustrated in FIG. 7, the analysis unit 132 includes an input unit 710, a CNN unit 720, an important feature map generation unit 730, an aggregation unit 740, a quantization value generation unit 750, and an output unit 760.

The input unit 710 acquires the decoded data from the decoding unit 131. The input unit 710 notifies the CNN unit 720 of the acquired decoded data.

The CNN unit 720 has a trained model. The CNN unit 720 performs the recognition processing for the object to be recognized included in the decoded data by inputting the decoded data.

The important feature map generation unit 730 generates an important feature map from an error calculated based on the recognition result obtained when a trained model has performed the recognition processing for the decoded data, using an error back propagation method.

The important feature map generation unit 730 generates the important feature map by using, for example, a back propagation (BP) method, a guided back propagation (GBP) method, or a selective BP method.

Note that the BP method is a method of visualizing a feature portion by calculating an error (an error with respect to a predetermined reference score) of each label from a score obtained by performing the recognition processing for the decoded data whose recognition result is a correct answer label and forming an image of magnitude of a gradient obtained by back propagation up to an input layer. Furthermore, the GBP method is a method of visualizing a feature portion by forming an image of only positive values of gradient information as the feature portion.

Moreover, the selective BP method is a method in which back propagation is performed using the BP method or the GBP method after maximizing only the errors of the correct answer labels. In the case of the selective BP method, the feature portion to be visualized is a feature portion that affects only the score of the correct answer label.

As described above, the important feature map generation unit 730 uses an error back propagation result by the error back propagation method such as the BP method, the GBP method, or the selective BP method. Thereby, the important feature map generation unit 730 can analyze the signal flow and strength of each path in the CNN unit 720 from the input of the decoded data to the output of the recognition result. As a result, according to the important feature map generation unit 730, it is possible to visualize which area of the input decoded data affects the recognition result to what extent.

Note that the method of generating the important feature map by the error back propagation method is disclosed in documents such as

“Selvaraju, Ramprasaath R., et al. “Grad-cam: Visual explanations from deep networks via gradient-based localization”, The IEEE International Conference on Computer Vision (ICCV), 2017, pp. 618-626”, for example.

The aggregation unit 740 aggregates the degree of influence of each area on the recognition result in units of blocks based on the important feature map and calculates the aggregated value of the degree of influence for each block. Furthermore, the aggregation unit 740 stores the calculated aggregated value of each block in an aggregation result storage unit 770 in association with the quantization value.

The quantization value generation unit 750 is an example of a calculation unit, and generates the quantization value map while changing the quantization value for each block based on the aggregation result stored in the aggregation result storage unit 770. Furthermore, the quantization value generation unit 750 generates the quantization value map while determining the quantization value having the limit compression ratio for each block.

The output unit 760 notifies the update unit 133 of the quantization value map (the quantization value map in which the quantization value having the limit compression ratio is set or the quantization value map in which the quantization value in the ongoing process to reach the limit compression ratio is set) generated by the quantization value generation unit 750.

### Specific Example of Aggregation Result

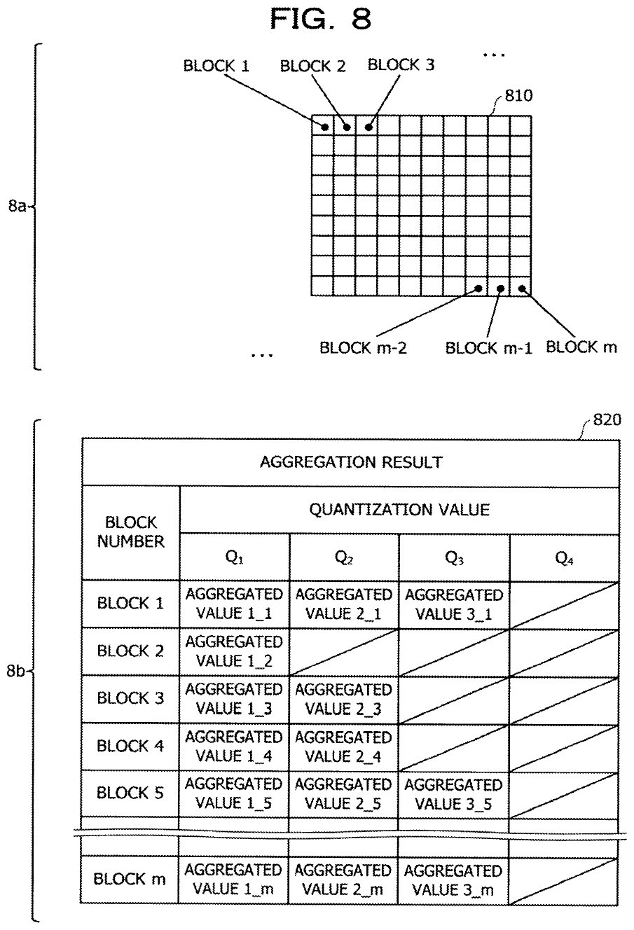

Next, a specific example of the aggregation result stored in the aggregation result storage unit 770 will be described. FIG. 8 is a diagram illustrating a specific example of the aggregation result. In the drawing, 8a illustrates an arrangement example of blocks at the time of encoding in a frame image 810. As indicated by 8a, in the present embodiment, for simplification of description, it is assumed that all the blocks in the frame image 810 have the same dimensions. Furthermore, in the example of 8a, the block number of the upper left block of the frame image 810 is assumed as “block 1”, and the block number of the lower right block is assumed as “block m”.

Furthermore, as indicated by 8b, an aggregation result 820 includes “block number” and “quantization value” as information items.

In the “block number”, the block number of each block in the frame image 810 is stored. In the “quantization value”, the quantization value settable when the encoding unit 121 performs the encoding processing is stored.

Note that, in the example of 8b, for simplification of description, only four types of quantization values (“Q₁” to “Q₄”) are illustrated. However, it is assumed that four or more types of quantization values are settable in the encoding processing by the encoding unit 121.

Furthermore, in the aggregation result 820, the aggregated value obtained by
performing the encoding processing for the frame image 810, using the corresponding quantization value, and
being aggregated in the corresponding block based on the important feature map calculated when the recognition processing is performed for the decoded data
is stored in the field associated with the “block number” and “quantization value”.

### Specific Example of Processing by Quantization Value Generation Unit

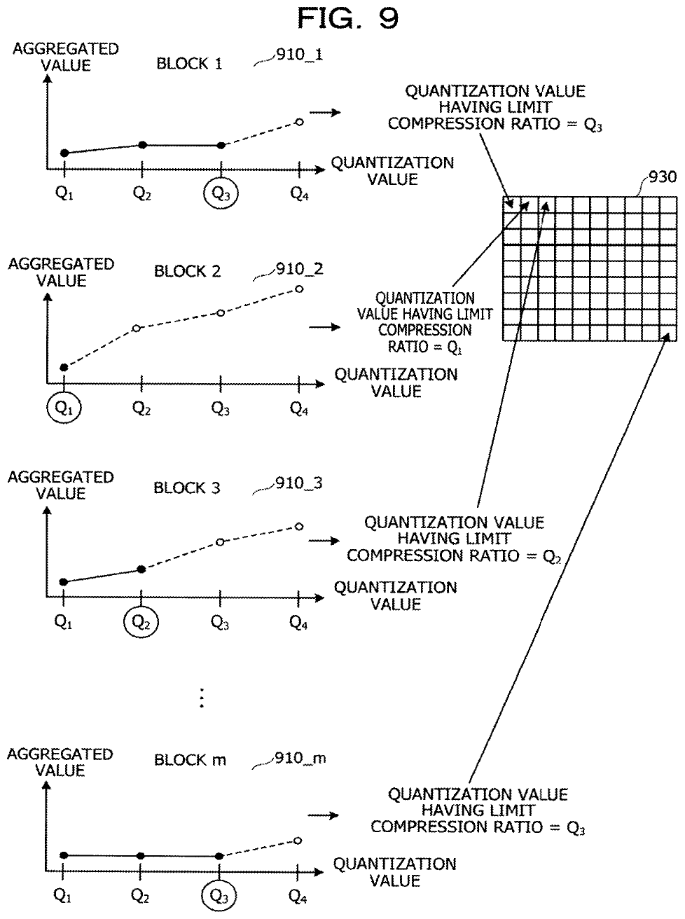

Next, a specific example of processing by the quantization value generation unit 750 will be described. FIG. 9 is a diagram illustrating a specific example of the processing by the quantization value generation unit. In FIG. 9, graphs 910_1 to 910_m are graphs generated by plotting the aggregated values of each block included in the aggregation result 820, with the quantization value on the horizontal axis and the aggregated value on the vertical axis.

As illustrated in the graph 910_1 to 910_m, a change in the aggregated value in the case where the encoding processing is performed using the quantization value differs for each block. The quantization value generation unit 750 determines, for example, the quantization value that satisfies any of the following conditions:
in a case where magnitude of the aggregated value exceeds a predetermined threshold,
in a case where an amount of change in the aggregated value exceeds a predetermined threshold,
in a case where a slope of the aggregated value exceeds a predetermined threshold, or
in a case where a change in the slope of the aggregated value exceeds a predetermined threshold,
as the quantization value having the limit compression ratio of each block.

The example of FIG. 9 illustrates that the quantization value generation unit 750 determines that the quantization value having the limit compression ratio as “Q₃” based on the graph 910_1. Furthermore, the example of FIG. 9 illustrates that the quantization value generation unit 750 determines that the quantization value having the limit compression ratio as “Q₁” based on the graph 910_2. Furthermore, the example of FIG. 9 illustrates that the quantization value generation unit 750 determines that the quantization value having the limit compression ratio as “Q₂” based on the graph 910_3. Moreover, the example of FIG. 9 illustrates that the quantization value generation unit 750 determines that the quantization value having the limit compression ratio as “Q₃” based on the graph 910_m.

In FIG. 9, reference numeral 930 indicates a state in which the quantization value having the limit compression ratio is set for the blocks 1 to m and the quantization value map is generated.

### Functional Configuration of Update Unit

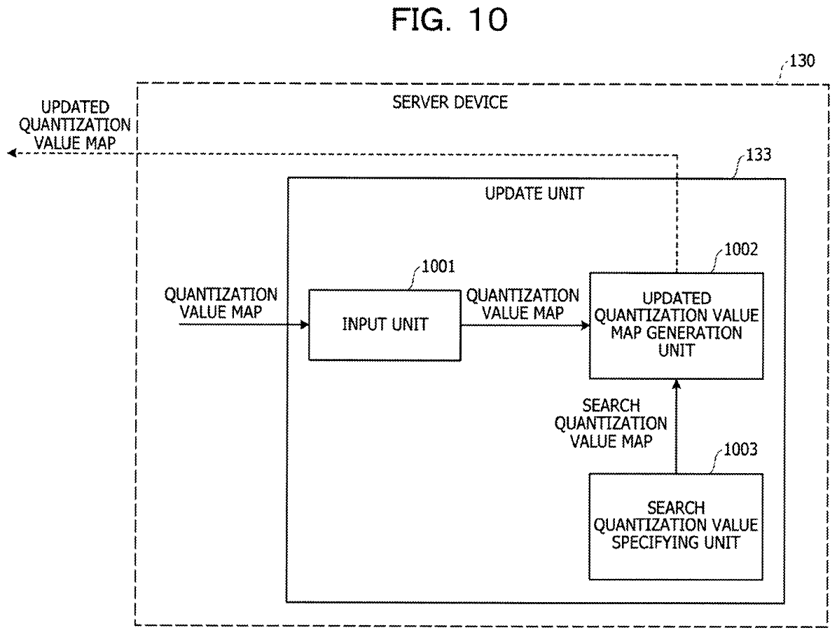

Next, a functional configuration of the update unit 133 will be described. FIG. 10 is a diagram illustrating an example of the functional configuration of the update unit. As illustrated in FIG. 10, the update unit 133 includes an input unit 1001, an updated quantization value map generation unit 1002, and a search quantization value specifying unit 1003.

The input unit 1001 acquires the quantization value map notified from the analysis unit 132 and notifies the updated quantization value map generation unit 1002 of the map.

The search quantization value specifying unit 1003 is an example of a specifying unit, and generates search quantization value maps 151 to 153. For example, the search quantization value specifying unit 1003 specifies:
the position and size of the band-shaped area, and
the quantization value set for the band-shaped area.

Then, the search quantization value specifying unit 1003 divides the image into a plurality of band-shaped areas based on the specified position and size of the band-shaped area, sequentially selects any one of the band-shaped areas in a predetermined order, and sets the specified quantization value, thereby generating the search quantization value map.

The updated quantization value map generation unit 1002 is an example of a setting unit, and generates the updated quantization value map by superimposing the search quantization value map generated by the search quantization value specifying unit 1003 on the quantization value map notified from the input unit 1001, and transmits the updated quantization value map to the edge device 120.

### Flow of Encoding Processing

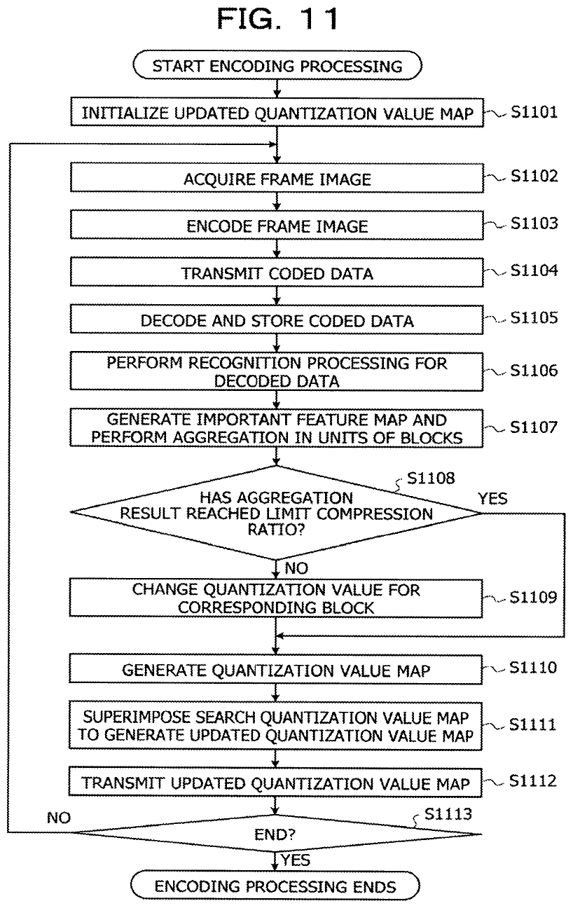

Next, a flow of the encoding processing by the encoding system 100 will be described. FIG. 11 is a flowchart illustrating a flow of the encoding processing.

In step S1101, the server device 130 initializes the updated quantization value map, sets the updated quantization value map in the edge device 120, and starts acquisition of the moving image data captured by the imaging device 110.

In step S1102, the edge device 120 acquires a frame image.

In step S1103, the edge device 120 encodes the frame image using the updated quantization value map to generate coded data.

In step S1104, the edge device 120 transmits the coded data to the server device 130.

In step S1105, the server device 130 decodes the coded data transmitted from the edge device 120, and stores decoded data in the decoded data storage unit 134.

In step S1106, the server device 130 performs the recognition processing for the decoded data.

In step S1107, the server device 130 generates the important feature map from the error (the error with respect to the predetermined reference score) of when the recognition processing is performed, using the error back propagation method. Furthermore, the server device 130 aggregates the generated important feature map in units of blocks.

In step S1108, the server device 130 determines, for each block, whether the aggregation result has reached the limit compression ratio. In step S1108, in a case where it is determined that the aggregation result has not reached the limit compression ratio (in the case of No in step S1108), the processing proceeds to step S1109.

In step S1109, the server device 130 changes the quantization value for the block of which the aggregation result has not reached the limit compression ratio (for example, Q₁→Q₂), and then proceeds to step S1110.

On the other hand, in step S1108, in a case where it is determined that the aggregation result has reached the limit compression ratio (in the case of Yes in step S1108), the processing directly proceeds to step S1110 (for example, without changing the quantization value).

In step S1110, the server device 130 generates the quantization value map.

In step S1111, the server device 130 superimposes the search quantization value map on the generated quantization value map to generate an updated quantization value map.

In step S1112, the server device 130 transmits the generated updated quantization value map to the edge device 120.

In step S1113 the edge device 120 determines whether to terminate the encoding processing. In step S1113, in a case where it is determined not to terminate the encoding processing (in the case of No in step S1113), the processing returns to step S1102.

On the other hand, in step S1113, in a case where it is determined to terminate the encoding processing (in the case of Yes in step S1113), the encoding processing ends.

As is clear from the above description, the encoding system 100 according to the first embodiment calculates, for each block, the quantization value having the compression ratio according to the degree of influence on the recognition accuracy at the time of the recognition processing, for the frame image of the time T1. Furthermore, the encoding system 100 according to the first embodiment sets the quantization value calculated for each block for the each block of the frame image of the time T2 acquired after the frame image of the time T1. At that time, the encoding system 100 according to the first embodiment sets the quantization value having the compression ratio lower than the calculated compression ratio for the specific area (the area on which the search quantization value map is superimposed) other than the area corresponding to the area of the object to be recognized included in the frame image of the time T1.

As described above, by lowering and setting the quantization value for the specific area at the time of the encoding processing, it is possible to perform the recognition processing corresponding to the appearance of the new object to be recognized according to the first embodiment.

As a result, according to the first embodiment, it is possible to suppress the influence on the recognition accuracy caused by the encoding processing of the moving image.

### Second Embodiment

In the above-described first embodiment, the case of using the search quantization value map in order to cope with appearance of the new object to be recognized has been described. However, the method for coping with appearance of the new object to be recognized is not limited thereto.

For example, when an edge device detects an object that has newly appeared and performs encoding processing for a frame image thereof, it may be configured to correct a quantization value map for an area where the object that has newly appeared is located and then perform the encoding processing. Hereinafter, regarding a second embodiment, differences from the above-described first embodiment will be mainly described.

### System Configuration of Encoding System

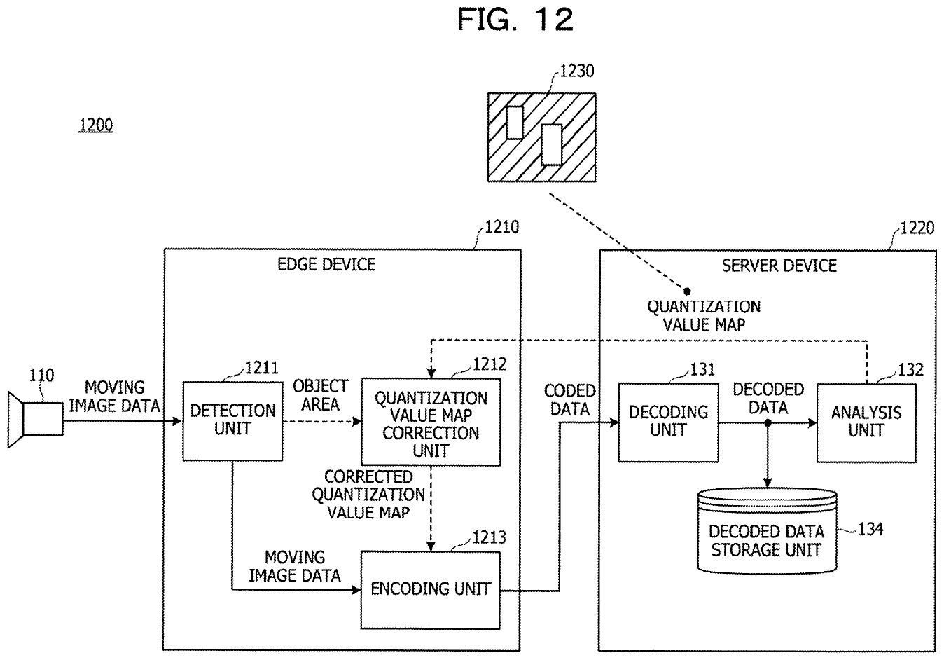

First, a system configuration of an encoding system according to the second embodiment will be described. FIG. 12 is a second diagram illustrating an example of the system configuration of the encoding system. A difference from the encoding system 100 illustrated in FIG. 1 is that, in a case of an encoding system 1200, functions implemented in an edge device 1210 and a server device 1220 are different from the functions implemented in the edge device 120 and the server device 130.

As illustrated in FIG. 12, the edge device 1210 functions as a detection unit 1211, a quantization value map correction unit 1212, and an encoding unit 1213 by executing an encoding program.

The detection unit 1211 detects an object (specifies position and size of the object) in each frame image of moving image data captured by an imaging device 110.

Note that the object detection function in the detection unit 1211 may be a function of directly detecting an object or a function of indirectly detecting an object. In the case of the function of directly detecting an object, a method of using a large amount of calculation, a method of correctly detecting type and position of the object, or the like may be used. Alternatively, a method of using a small amount of calculation, a method of obtaining sufficient information for comparing the type and position of the object with the quantization value map, or the like may be used. For example, the object detection function in the detection unit 1211 may be an advanced detection function such as a recognition engine or the like, or may be a function capable of detecting some change between frame images. For example, the object detection function may be a function of detecting an object by computer vision, a function of detecting an object by machine learning, a function of detecting a change in color, or the like.

Furthermore, in the case of the function of indirectly detecting an object, a method of predicting the position of the object based on information of the quantization value map obtained in the past may be used without explicitly performing object detection processing by the edge device 1210. Note that both the function of directly detecting an object and the function of indirectly detecting an object may be provided in the detection unit 1211, and both methods may be used in combination.

The quantization value map correction unit 1212 is another example of the setting unit, and corrects the quantization value map transmitted from the server device 1220 based on a detection result in the detection unit 1211. For example, the quantization value map correction unit 1212 corrects the quantization value of the block corresponding to the area of the object detected by the detection unit 1211 to a low value among the quantization values of the respective blocks of the quantization value map transmitted from the server device 1220.

For example, the quantization value map correction unit 1212 lowers and sets the quantization value of the block included in the area of the detected object (=specific area) in an area other than an area corresponding to an area of the object to be recognized.

The encoding unit 1213 encodes each frame image of the moving image data, using the corrected quantization value map (referred to as a corrected quantization value map) corrected by the quantization value map correction unit 1212 to generate coded data. Furthermore, the encoding unit 121 transmits the generated coded data to the server device 130.

The server device 1220 functions as a decoding unit 131 and an analysis unit 132 by executing a decoding program.

The decoding unit 131 decodes the coded data transmitted from the edge device 1210 to generate decoded data. The decoding unit 131 stores the generated decoded data in a decoded data storage unit 134. Furthermore, the decoding unit 131 notifies the analysis unit 132 of the generated decoded data.

The analysis unit 132 analyzes the decoded data notified from the decoding unit 131 and generates the quantization value map. For example, the analysis unit 132 calculates a degree of influence on recognition accuracy, of each area of the decoded data at the time of recognition processing, by performing the recognition processing for the decoded data. Furthermore, the analysis unit 132 aggregates the degree of influence of each area for each block and calculates the quantization value according to an aggregation result to generate a quantization value map 1230 according to the degree of influence on the recognition accuracy. The analysis unit 132 transmits the generated quantization value map 1230 to the edge device 1210.

### Relationship (1) Between Corrected Quantization Value Map and Recognition Result

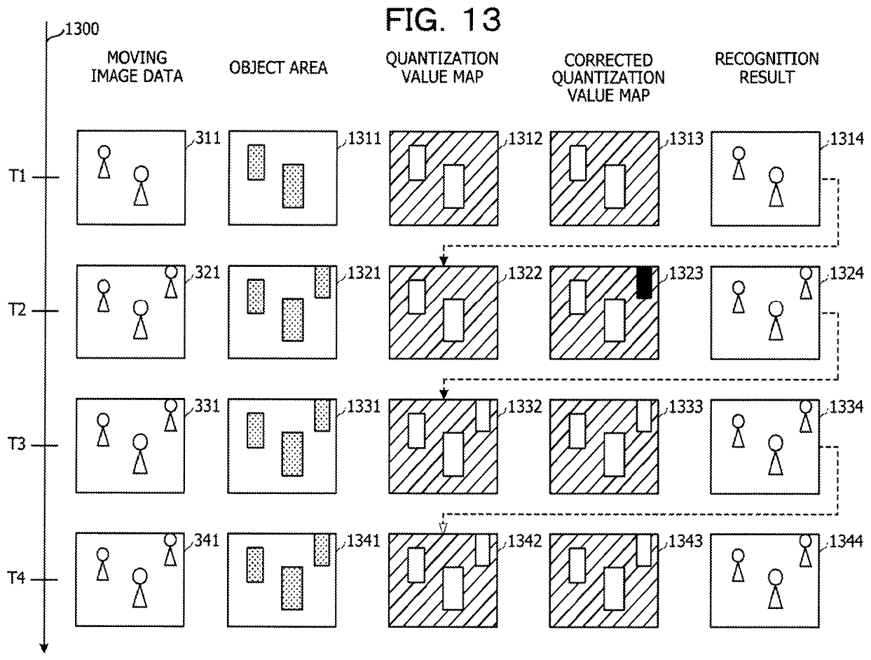

Next, a relationship among the area of the object detected in each frame image of the moving image, the corrected quantization value map obtained by correcting the quantization value map to be applied to each frame image of the moving image, and a recognition result for the corresponding decoded data will be described. FIG. 13 is a first diagram illustrating the relationship between the corrected quantization value map to be applied to each frame image of the moving image and the recognition result.

In FIG. 13, a vertical axis 1300 represents a time axis, and the example of FIG. 13 indicates that the edge device 1210 has acquired frame images 311 to 341 of the moving image at time T1 to time T4, respectively. Note that, in the case of the example of FIG. 13, while two persons are included in the frame image 311 as the objects to be recognized at the time T1, three persons are included in the frame images 321, 331, and 341 as the objects to be recognized at the time T2 to time T4.

Furthermore, the example of FIG. 13 illustrates a state in which the edge device 1210 has performed the object detection processing for the frame image 311 acquired at the time T1 and has detected two persons (see a detection result 1311). Moreover, the example of FIG. 13 illustrates a state in which the edge device 120 has performed the encoding processing for the frame image 311 without correcting a quantization value map 1312 (see a corrected quantization value map 1313). Moreover, the example of FIG. 13 illustrates a state in which the server device 1220 decodes coded data generated by performing the encoding processing for the frame image 311 and performs the recognition processing for the decoded data to obtain a recognition result 1314.

According to the example of FIG. 13, by use of the quantization value map 1312 in which the quantization value of the area corresponding to the area in which the objects to be recognized (two persons) are located in the frame image 311 is set to be low, the area of the object to be recognized is reproduced with accuracy in the decoded data. As a result, the server device 1220 can recognize the objects to be recognized (two persons) in the decoded data.

Note that, in this case, the server device 1220 generates the quantization value map according to the recognition result 1314. The example of FIG. 13 illustrates a state in which a quantization value map 1322 is generated according to the recognition result 1314.

Furthermore, the example of FIG. 13 illustrates a state in which the edge device 1210 has performed the object detection processing for the frame image 321 acquired at the time T2 and has detected three persons (see a detection result 1321). Moreover, the example of FIG. 13 illustrates a state in which the edge device 1210 corrects the quantization value map 1322 based on the detection result 1321 and generates a corrected quantization value map 1323. Moreover, the example of FIG. 13 illustrates a state in which the edge device 1210 has performed the encoding processing for the frame image 321, using the corrected quantization value map 1323. Moreover, the example of FIG. 13 illustrates a state in which the server device 1220 decodes coded data generated by performing the encoding processing for the frame image 321 and performs the recognition processing for the decoded data to obtain a recognition result 1324.

According to the example of FIG. 13, by use of the corrected quantization value map 1323 in which the quantization value of the area corresponding to the area in which the objects to be recognized (three persons) are located in the frame image 321 is set to be low, the area of the object to be recognized is reproduced with accuracy in the decoded data. As a result, the server device 1220 can recognize the objects to be recognized (three persons) in the decoded data.

Note that, in this case, the server device 1220 generates the quantization value map according to the recognition result 1324. The example of FIG. 13 illustrates a state in which a quantization value map 1332 is generated according to the recognition result 1324.

Furthermore, the example of FIG. 13 illustrates a state in which the edge device 1210 has performed the object detection processing for the frame image 331 acquired at the time T3 and detected three persons (see a detection result 1331). Moreover, the example of FIG. 13 illustrates a state in which the edge device 1210 has performed the encoding processing without correcting the quantization value map 1332 (see a corrected quantization value map 1333). Moreover, the example of FIG. 13 illustrates a state in which the server device 1220 decodes coded data generated by performing the encoding processing for the frame image 331 and performs the recognition processing for the decoded data to obtain a recognition result 1334.

According to the example of FIG. 13, by use of the quantization value map 1332 in which the quantization value of the area corresponding to the area in which the objects to be recognized (three persons) are located in the frame image 331 is set to be low, the area of the object to be recognized is reproduced with accuracy in the decoded data. As a result, the server device 1220 can recognize the objects to be recognized (three persons) in the decoded data.

Note that, in this case, the server device 1220 generates the quantization value map according to the recognition result 1334. The example of FIG. 13 illustrates a state in which a quantization value map 1342 is generated according to the recognition result 1334. Thereafter, at the time T4, processing similar to the processing at the time T3 is performed.

In this manner, it is possible to recognize the new object to be recognized by correcting the quantization value map based on the area of the detected object.

### Relationship (2) Between Corrected Quantization Value Map and Recognition Result

Next, the relationship among the area of the object detected in each frame image of the moving image, the corrected quantization value map obtained by correcting the quantization value map to be applied to each frame image of the moving image, and the recognition result for the corresponding decoded data will be described using a specific example different from FIG. 13.

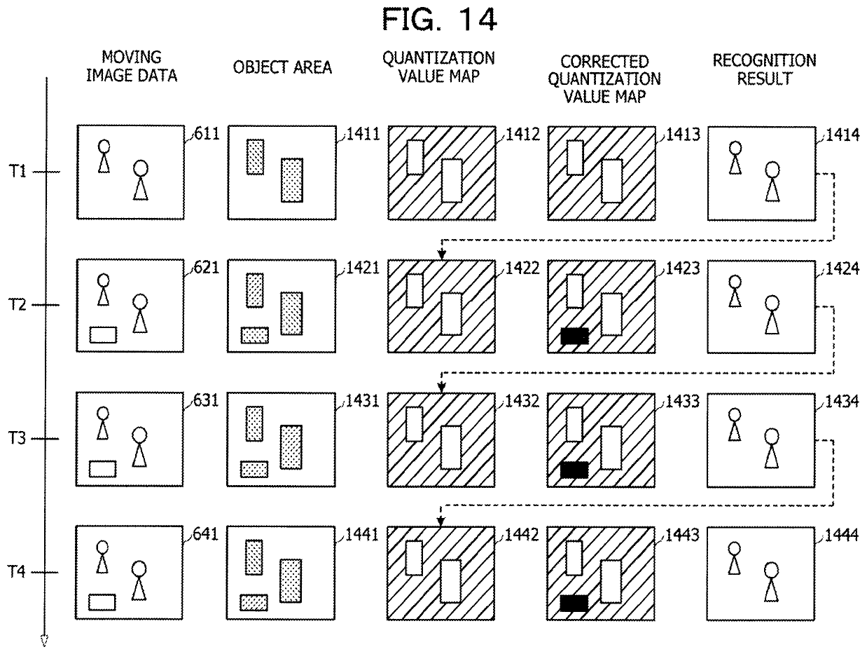

FIG. 14 is a second diagram illustrating the relationship between the corrected quantization value map to be applied to each frame image of the moving image and the recognition result. A difference from FIG. 13 is the frame image at each time.

For example, the new object to be recognized appears at the time T2 in FIG. 13, whereas the new object (object not to be recognized) appears at time T2 in FIG. 14.

In the case of the example of FIG. 14, the edge device 1210 detects two persons and one object by performing object detection processing for the frame image 621 acquired at the time T2 (see a detection result 1421). Furthermore, in the case of the example of FIG. 14, the edge device 1210 corrects a quantization value map 1422 based on the detection result 1421 and generates a corrected quantization value map 1423. Furthermore, in the case of the example of FIG. 14, the edge device 1210 performs the encoding processing for the frame image 621 using the corrected quantization value map 1423. Moreover, in the example of FIG. 14, the server device 1220 decodes coded data generated by performing the encoding processing for the frame image 621 and performs the recognition processing for the decoded data to obtain a recognition result 1424.

According to the example of FIG. 14, the corrected quantization value map 1423 in which the quantization value of the area corresponding to the area where the objects to be recognized (two persons) and one object not to be recognized are located in the frame image 621 is set to be low is used. Therefore, in the decoded data, the object to be recognized and the object not to be recognized are reproduced with high accuracy.

However, since the server device 1220 does not recognize the object not to be recognized and recognizes only the object to be recognized, the recognition result 1424 is generated.

Note that, in this case, the server device 1220 generates the quantization value map according to the recognition result 1424. The example of FIG. 14 illustrates a state in which a quantization value map 1432 is generated according to the recognition result 1424. Thereafter, at the time T3 and time T4, processing similar to the processing at the time T2 is performed.

### Flow of Encoding Processing

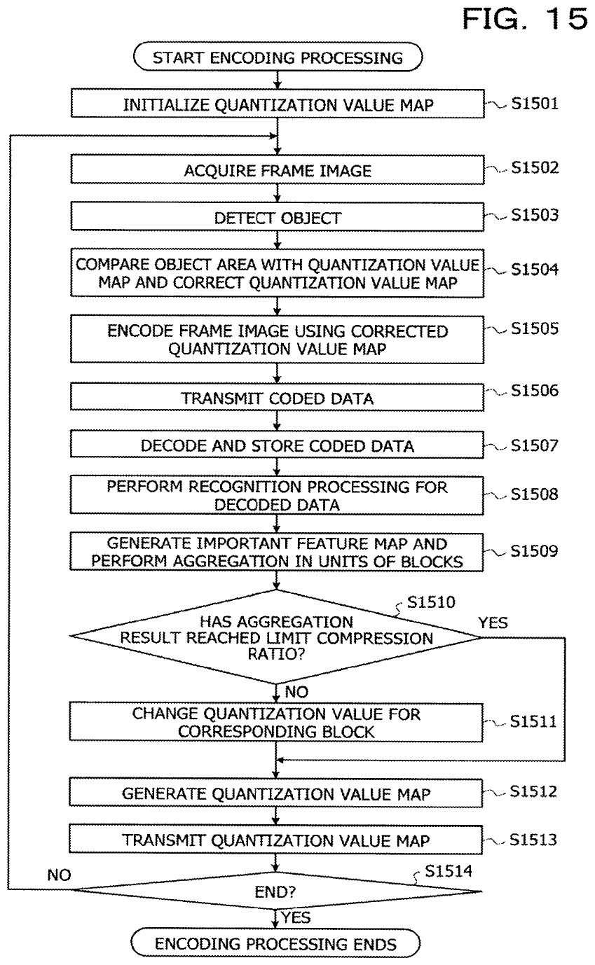

Next, a flow of the encoding processing by the encoding system 1200 will be described. FIG. 15 is a flowchart illustrating a flow of the encoding processing.

In step S1501, the server device 1220 initializes the quantization value map, sets the quantization value map in the edge device 1210, and starts acquisition of moving image data captured by the imaging device 110.

In step S1502, the edge device 1210 acquires a frame image.

In step S1503, the edge device 1210 detects an object in the frame image and specifies an area of the detected object.

In step S1504, the edge device 1210 compares the specified area of the object with the quantization value map and corrects the quantization value map.

In step S1505, the edge device 1210 encodes the frame image using the corrected quantization value map to generate coded data.

In step S1506, the edge device 1210 transmits the coded data to the server device 1220.

In step S1507, the server device 1220 decodes the coded data transmitted from the edge device 1210, and stores decoded data in the decoded data storage unit 134.

In step S1508, the server device 1220 performs the recognition processing for the decoded data.

In step S1509, the server device 1220 generates an important feature map from an error (an error with respect to a predetermined reference score) of when the recognition processing is performed, using an error back propagation method. Furthermore, the server device 1220 aggregates the generated important feature map in units of blocks.

In step S1510, the server device 1220 determines, for each block, whether an aggregation result has reached a limit compression ratio. In step S1510, in a case where it is determined that the aggregation result has not reached the limit compression ratio (in the case of No in step S1510), the processing proceeds to step S1511.

In step S1511, the server device 1220 changes the quantization value for the block of which the aggregation result has not reached the limit compression ratio (for example, Q₁→Q₂), and then proceeds to step S1512.

On the other hand, in step S1510, in a case where it is determined that the aggregation result has reached the limit compression ratio (in the case of Yes in step S1510), the processing directly proceeds to step S1512 (for example, without changing the quantization value).

In step S1512, the server device 1220 generates the quantization value map.

In step S1513, the server device 1220 transmits the generated quantization value map to the edge device 1210.

In step S1514, the edge device 1210 determines whether to terminate the encoding processing. In step S1514, in a case where it is determined not to terminate the encoding processing (in the case of No in step S1514), the processing returns to step S1502.

On the other hand, in step S1514, in a case where it is determined to terminate the encoding processing (in the case of Yes in step S1514), the encoding processing ends.

As is clear from the above description, the encoding system 1200 according to the second embodiment calculates, for each block, the quantization value having the compression ratio according to the degree of influence on the recognition accuracy at the time of the recognition processing and generates the quantization value map, for the frame image of the time T1. Furthermore, the encoding system 1200 according to the second embodiment sets the quantization value map calculated for the each block of the frame image of the time T2 acquired after the frame image of the time T1. At that time, the encoding system 1200 according to the second embodiment performs the object detection processing, and corrects the quantization value of the area other than the area corresponding to the area of the object to be recognized, and of the area of the detected object (specific area), to have the compression ratio lower than the calculated compression ratio.

As described above, by lowering and setting the quantization value for the specific area at the time of the encoding processing, it is possible to perform the recognition processing corresponding to the appearance of the new object to be recognized according to the second embodiment.

As a result, according to the second embodiment, it is possible to suppress the influence on the recognition accuracy caused by the encoding processing of the moving image.

### Third Embodiment

The above-described first and second embodiments have been described that the quantization value map is generated while the limit compression ratio is determined for the decoded data. However, the method of generating the quantization value map is not limited thereto.

For example, it may be configured to determine a limit compression ratio, correct a quantization value having the determined limit compression ratio slightly in a low compression direction, and then generate a quantization value map.

Note that, in generating the corrected quantization value map, a correction amount in the low compression direction may be a predetermined fixed value. Alternatively, it may be configured to monitor transition of recognition accuracy during recognition processing, and adaptively determine the correction amount in consideration of a change rate of accuracy deterioration or the like in a case where a sign of the accuracy deterioration is detected.

Furthermore, the correction in the low compression direction may be executed in a server device or in an edge device.

### Other Embodiments

In each of the above-described embodiments, the functions implemented by the edge device and the functions implemented by the server device, of the encoding system, have been described with reference to, for example, FIG. 1, FIG. 12, and the like. However, in the encoding system, the functions implemented by the edge device and the functions implemented by the server device are not limited to the examples illustrated in FIGS. 1 and 12.

For example, in the first embodiment, the quantization value generation unit 750 and the update unit 133 of the analysis unit 132 may be implemented in the edge device 120 (for example, they may be implemented by executing the encoding program).

Furthermore, in each of the above-described embodiments, for simplification of description, the case where the object to be recognized does not move in each of the frame images 311 to 341 and 611 to 641 of the moving image data has been described. However, the object to be recognized may move between frame images. Note that, in that case, it is assumed that the quantization value map is corrected by predicting a movement direction and a movement amount of the object to be recognized.

Furthermore, the above-described first embodiment has been described that the updated quantization value map on which the search quantization value map is superimposed is applied to each frame image of the moving image. However, the frequency of applying the updated quantization value map is not limited thereto, and for example, the updated quantization value map obtained by superimposing the search quantization value map may be applied to the frame image once every predetermined number of frame images.

Similarly, the above-described second embodiment has been described that the corrected quantization value map is applied to each frame image of the moving image. However, the frequency of applying the corrected quantization value map is not limited thereto, and for example, the corrected quantization value map may be applied to the frame image once every predetermined number of frame images.

Furthermore, the above-described first and second embodiments has been described that all the areas of the new objects to be recognized are included in the areas where the quantization value is decreased and reproducibility is increased in the search quantization value map or the corrected quantization value map. However, all the areas of the new objects to be recognized may not be included in the areas where the quantization value is decreased and reproducibility is increased in the search quantization value map or the corrected quantization value map.

For example, it is sufficient if there is information by which the CNN unit 720 or the like can identify the existence of the new object to be recognized in the area of the new object to be recognized. For example, in the case where the CNN unit 720 or the like can identify the existence of the new object to be recognized in a part of the area of the new object to be recognized, it is sufficient if there is information of the part of the area. Furthermore, even in a case where the part of the area of the new object to be recognized is hidden, for example, in a case where the CNN unit 720 or the like can estimate the hidden part of the area, the part of the area of the new object to be recognized may not be included.

In these cases, even if not all the areas of the new objects to be recognized are included, the quantization value generation unit 750 can generate the quantization value map that reflects all the areas of the new objects to be recognized.

Furthermore, in the above-described first embodiment, the search quantization value map is formed in a band shape, but the shape of the search quantization value map may be determined based on, for example, a characteristic (shape, size, or operation) of the object to be recognized included in the moving image data. For example, in a case where it is assumed that a vertically long object to be recognized is included in the moving image data as in a case where a person walking in town is the object to be recognized, the search quantization value map may be formed using a vertically long rectangle.

Furthermore, in the above-described third embodiment, the purpose of the correction in the low compression direction has not been particularly mentioned, but the correction in the low compression direction may be performed in order to observe a change in the size of the aggregated value, for example. Alternatively, in a case where the quantization value map is generated by a method other than the methods described in the above-described first and second embodiments, and it is effective to correct the quantization value in the low compression direction to a minute extent, the correction in the low compression direction may be performed. Alternatively, the correction in the low compression direction may be performed simply for the purpose of providing a margin.

Note that the embodiment is not limited to the configurations described here and may include, for example, combinations of the configurations or the like described in the above embodiments and other elements. These points may be changed without departing from the spirit of the embodiments and may be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An encoding system comprising:
a memory; and
a processor coupled to the memory and configured to:
calculate, for each area, for a first image, a quantization value that has a compression ratio according to a degree of influence on recognition accuracy during recognition processing;
set, when setting the quantization value calculated for each area, for each area of a second image that is acquired after the first image, a quantization value that has a compression ratio lower than the compression ratio, for a specific area other than an area that corresponds to an area of an object to be recognized included in the first image; and
encode the second image, using the quantization value.

2. The encoding system according to claim 1, wherein the processor:
sequentially selects in a predetermined order, at least one area obtained in a case where an image is divided into a plurality of areas; and
sets the quantization value that has a compression ratio lower than the compression ratio, for the specific area that is the area, of the area other than the area that corresponds to the area of the object to be recognized.

3. The encoding system according to claim 1, wherein the processor:
detects an object included in the second image; and
sets the quantization value that has a compression ratio lower than the compression ratio, for the specific area that is an area of the object detected from the second image, of the area other than the area that corresponds to the area of the object to be recognized.

4. The encoding system according to claim 2, wherein the processor, when setting the quantization value that has the compression ratio calculated for each area, corrects the quantization value that has the compression ratio calculated for each area in a low compression direction, and sets the corrected quantization value.

5. An encoding method comprising:
calculating, for each area, for a first image, a quantization value that has a compression ratio according to a degree of influence on recognition accuracy during recognition processing;
setting, when setting the quantization value calculated for each area, for each area of a second image that is acquired after the first image, a quantization value that has a compression ratio lower than the compression ratio, for a specific area other than an area that corresponds to an area of an object to be recognized included in the first image; and
encoding the second image, using the quantization value.

6. A non-transitory computer-readable recording medium storing an encoding program causing a computer to execute a processing of:
calculating, for each area, for a first image, a quantization value that has a compression ratio according to a degree of influence on recognition accuracy during recognition processing;
setting, when setting the quantization value calculated for each area, for each area of a second image that is acquired after the first image, a quantization value that has a compression ratio lower than the compression ratio, for a specific area other than an area that corresponds to an area of an object to be recognized included in the first image; and
encoding the second image, using the quantization value.
